(19) United States
(12) Patent Application Publication
(10) Pub. No.: US 2020/0049732 A1
(43) Pub. Date: Feb. 13, 2020

(54) CHARGE OUTPUT ELEMENT AND ANNULAR SHEAR PIEZOELECTRIC ACCELERATION SENSOR

(71) Applicant: FATRI UNITED TESTING & CONTROL (QUANZHOU) TECHNOLOGIES CO., LTD., Quanzhou City (CN)

(72) Inventors: Yongzhong Nie, Quanzhou City (CN); Chuan Nie, Quanzhou City (CN)

(21) Appl. No.: 16/609,263

(22) PCT Filed: Apr. 23, 2018
(86) PCT No.: PCT/CN2018/084070

§ 371 Date: Oct. 29, 2019

(30) Foreign Application Priority Data
Sep. 15, 2017 (CN) 201710840720.2

(51) Int. Cl. G01P 15/09; G01P 15/08

(52) U.S. Cl. CPC G01P 15/0915; G01P 15/0802

(57) ABSTRACT

A charge output element, comprising: a base (110), which comprises a supporting part (111), a connecting part (112), and a mounting hole (113); a piezoelectric element (120), sleeved on the connecting part (112), an annular gap being formed between the piezoelectric element (120) and the connecting part (112); a mass block (130), sleeved on the piezoelectric element (120); a pre-tightening member (140), inserted in the annular gap; a locking member (150), having a columnar part (151) and a stop part (152) connected to each other, the columnar part (151) cooperating with the mounting hole (113) to lock the components above, and the stop part (152) pressing against a first end (142), so that the pre-tightening member (140) provides a radial pre-tightening force to tightly fix the piezoelectric element (120), the mass block (130), and the base (110). Since contact in the charge output element is all rigid, the contact rigidity of the overall structure can be greatly improved, and no adhesive is needed, thereby effectively shortening the mounting period of the charge output element. Also provided is an annular shear piezoelectric acceleration sensor comprising the charge output element.

### TECHNICAL FIELD

The present invention relates to the technical field of sensors, and in particular to a charge output element and an annular shear piezoelectric acceleration sensor.

### BACKGROUND ART

A piezoelectric sensor is assembled from various structures of different materials. Output signals of the piezoelectric sensor is in direct proportion to vibration acceleration suffered by a system, therefore, an overall contact stiffness of the system is insufficient due to the assembly from various structures of different materials, such that frequency response characteristics and resonance of the piezoelectric sensor are relatively low, thereby influencing reliability of output signals.

In order to realize installation of piezoelectric ceramics, a base and a mass block in an annular shear piezoelectric acceleration sensor, a manner of epoxy adhesive bonding is commonly adopted now. By adopting such a manner, although the problem of bonding between the piezoelectric ceramics and the base is solved, a higher requirement is put forward for the quality of epoxy glue between connecting layers and for the operation, for example, if the epoxy glue contains impurities or if bubbles are generated during operation, overall stiffness of products will be insufficient, then the overall stiffness of the sensor will be lowered, and frequency response characteristics will be influenced, in addition, the adhesion process requires a longer roasting time, then the installation period is rather long.

### SUMMARY OF THE INVENTION

An embodiment of the present invention provides a charge output element and an annular shear piezoelectric acceleration sensor, aiming at effectively shortening installation period while improving system stiffness.

One aspect of the embodiment of the present invention provides a charge output element, including a base, wherein the base includes a supporting part and a cylindrical connecting part arranged on the supporting part, and the connecting part is provided with mounting holes axially extending along the connecting part; a piezoelectric element, sleeved outside the connecting part, wherein a circular gap is formed between the piezoelectric element and the connecting part; a mass block, sleeved outside the piezoelectric element and arranged above the supporting part in a suspended manner; pre-tightening members, inserted into the circular gap, wherein the pre-tightening members are circularly distributed within the circular gap, the pre-tightening member includes a first end and a second end which are opposite to each other, the second end is close to the supporting part, and the thickness of the first end of the pre-tightening member is larger than the thickness of the second end; and a locking member, including a columnar part and a stop part which are connected with each other, wherein the columnar part cooperates with the mounting hole to fasten the above elements, and the stop part butts against the first end of the pre-tightening member, such that the pre-tightening member provides a radial pretightening force to fasten the piezoelectric element, the mass block and the base.

According to one aspect of the present invention, the pre-tightening member includes at least two wedge blocks, wherein the at least two wedge blocks are distributed circularly within the circular gap along a circumferential direction of the connecting part, and the thickness of each wedge block is linearly decreased along a direction from the first end to the second end.

According to one aspect of the present invention, the at least two wedge blocks are formed by cutting a wedge ring along its axial direction.

According to one aspect of the present invention, each wedge block includes an inner ring surface and an outer ring surface which are opposite to each other and which extend from the first end to the second end, wherein the inner ring surfaces of the at least two wedge blocks are both set to be fit with the connecting part, and the piezoelectric element is sleeved on the outer ring surfaces of the at least two wedge blocks.

According to one aspect of the present invention, the piezoelectric element is in direct contact with the outer ring surfaces of the at least two wedge blocks.

According to one aspect of the present invention, the outer ring surfaces of the at least two wedge blocks are vertically arranged.

According to one aspect of the present invention, the piezoelectric element includes at least two rounded valve bodies which are formed by cutting a circular ring along its axial direction.

According to one aspect of the present invention, an outer ring surface of the connecting part is provided with a supporting flange along its axial direction, wherein the supporting flange is higher than the plane in which the supporting part is located, and the piezoelectric element butts against the supporting flange.

According to one aspect of the present invention, the mass block has a circular structure which includes an inner ring surface and an outer ring surface opposite to each other, wherein the inner ring surface of the mass block is provided with a concave block, and the mass block is arranged outside the piezoelectric element in a hanging manner via the concave block.

Another aspect of the present invention provides a annular shear piezoelectric acceleration sensor which includes the above charge output element.

In an embodiment of the present invention, in the process in which the columnar part of the locking member cooperates with the mounting hole to fasten each element, a stop part presses against the first end of the pre-tightening member to descend. Since the thicknesses from the first end to the second end of the pre-tightening member are not consistent, the pre-tightening member is close to the supporting part under the pressure of the stop part. The pre-tightening member will expand outwards in its descending process to extrude the piezoelectric element, while a mass block is sleeved outside the piezoelectric element to prevent the piezoelectric element from expanding, such that the parts of the whole system are extruded mutually in the installation process of the locking member, all the parts are in tight fit, and system stiffness is improved. Since the parts and pieces of the charge output element are all in stiff contact, the contact stiffness of the overall structure is dramatically improved. As no viscose is needed, the installation period of the charge output element is effectively shortened.

### BRIEF DESCRIPTION OF THE DRAWINGS

Through reading a detailed description of the non-limiting embodiments made with reference to the accompanying drawings, other characteristics, objectives and advantages of the present invention will become more apparent, wherein the same or similar reference numerals represent the same or similar characteristics.

FIG. 1 is a structural schematic diagram of a charge output element of an embodiment of the present invention;

FIG. 2 is a sectional view along direction A-A in FIG. 1;

FIG. 3 is a structural schematic diagram of a pre-tightening member of a charge output element of an embodiment of the present invention;

FIG. 4 is a structural schematic diagram of a piezoelectric element of a charge output element of an embodiment of the present invention;

FIG. 5 is a structural schematic diagram of a base of a charge output element of an embodiment of the present invention.

### REFERENCE NUMERALS

100, charge output element; 110, base; 111, supporting part; 112, connecting part; 113, mounting hole; 114, supporting flange; 120, piezoelectric element; 130, mass block; 131, concave block; 140, pre-tightening member; 141, wedge block; 142, first end; 143, second end; 150 locking member; 151, columnar part; 152, stop part.

### DETAILED DESCRIPTION OF THE EMBODIMENTS

Characteristics and exemplary embodiments of various aspects of the present invention will be described in detail below. In the following brief description, multiple specific details are proposed, so as to provide an overall understanding of the present invention. However, for those skilled in the art, apparently, the present invention can be implemented under the condition of not needing some details of these specific details. The description of the embodiments below is merely for providing a better understanding of the present invention through showing examples of the present invention. The present invention is by no means limited to any specific configuration and algorithm proposed below, but covers any modification, substitution and improvement of elements, parts and algorithms under the premise of not departing from the spirit of the present invention. In the drawings and the following description, no well-known structure and technology is shown, so as to avoid unnecessary ambiguity of the present invention.

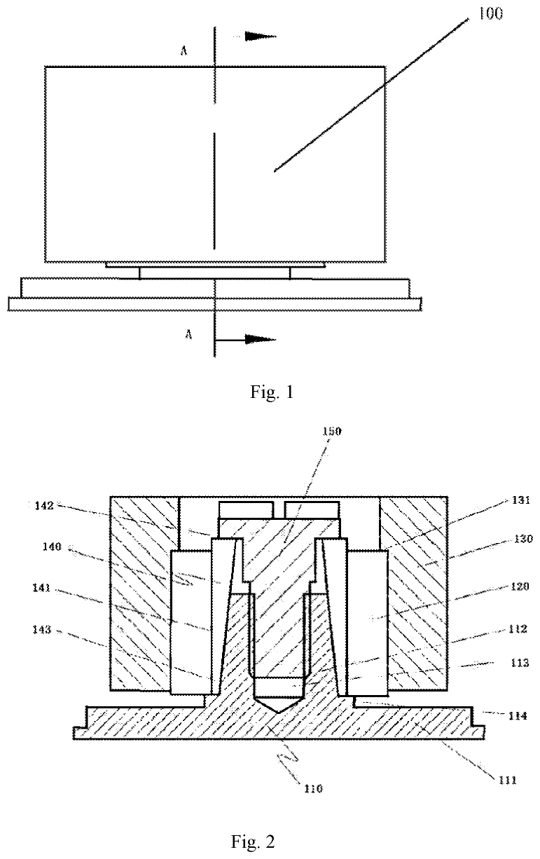

FIG. 1 and FIG. 2 show a charge output element provided by an embodiment of the present invention. The charge output element includes a base 110, wherein the base 110 includes a supporting part 111 and a cylindrical connecting part 112 arranged on the supporting part 111, and the connecting part 112 is provided with mounting holes 113 which extend axially along the connecting part 112; a piezoelectric element 120, sleeved outside the connecting part 112, wherein the piezoelectric element 120 and the connecting part 112 form a circular gap; a mass block 130, sleeved outside the piezoelectric element 120 and arranged above the supporting part 111 in a suspended manner; pre-tightening members 140, inserted into a circular gap, wherein the pre-tightening members 140 are circularly distributed within the circular gap, the pre-tightening member 140 includes a first end 142 and a second end 143 which are opposite to each other, the second end 143 is close to the supporting part 111, and the thickness of the first end 142 is larger than the thickness of the second end 143; and a locking member 150, including a columnar part 151 and a stop part 152 which are connected with each other, wherein the columnar part 151 cooperates with the mounting hole 113 to fasten the above elements, in the process in which the columnar part 151 cooperates with the mounting hole 113 to fasten each of the above elements, the stop part 152 butts against the first end 142, such that the pre-tightening member 140 provides a radial pretightening force to fasten the piezoelectric element 120, the mass block 130 and the base 110, wherein the thickness of the pre-tightening member 140 means the distance from an inner side wall, facing the connecting part 112, of the pre-tightening member 140 to an outer side wall, facing the piezoelectric element 120, of the pre-tightening member 140.

In an embodiment of the present invention, in the process in which the columnar part 151 of the locking member 150 cooperates with the mounting hole 113 to fasten each element, a stop part 152 presses against the first end 142 to descend. Since the thicknesses from the first end to the second end of the pre-tightening member 140 are not consistent, the pre-tightening member 140 is close to the supporting part 111 under the pressure of the stop part 152. The pre-tightening member will expand outwards to extrude the piezoelectric element 120, while a mass block 130 is sleeved outside the piezoelectric element 120 to prevent the piezoelectric element 120 from expanding, such that the parts of the whole system are extruded mutually in the installation process of the locking member 150, all the parts are in tight fit, and system stiffness is improved. Since the parts and pieces of the charge output element 100 are all in stiff contact, the contact stiffness of the overall structure is dramatically improved. As no viscose is needed, the installation period of the charge output element 100 is effectively shortened.

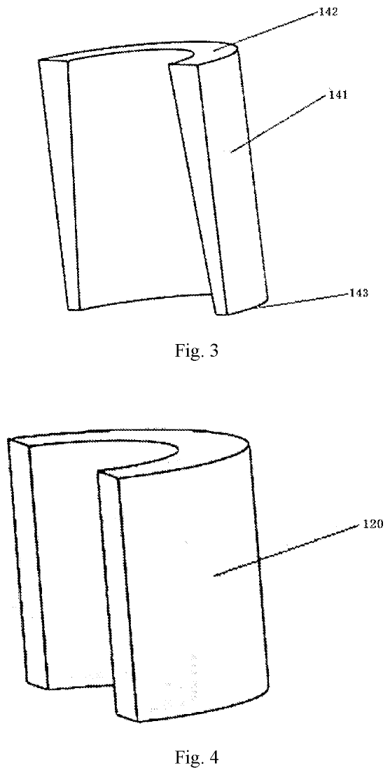

Please refer to FIG. 3, in some optional embodiments, the pre-tightening member 140 includes two wedge blocks 141. In order to improve mutual fit degree between each wedge block 141, two wedge blocks 141 are formed by axially cutting a wedge ring, and the two wedge blocks 141 are circularly distributed within the circular gap along the axial direction of the connecting part 112. Each wedge block 141 includes an inner ring surface and an outer ring surface which are opposite to each other and which extend from the first end 142 to the second end 143, wherein the inner ring surface of each wedge block is set to be fit with the connecting part 112, and the piezoelectric element 120 is sleeved outside the wedge block 141. The piezoelectric element 120 is in direct contact with an outer ring surface of the wedge block 141, namely, the outer ring surface of the wedge block 141 is set to be fit with the piezoelectric element 120, wherein the so-called setting to be fit herein means setting to be in direct contact, such that when the at least two wedge blocks 141 are subjected to a downward pressing force, the at least two wedge blocks 141 slide downwards along the surface of the connecting part 112 and the piezoelectric element 120. The wedge block 141 is more closely fit with the connecting part 112, such that the wedge block 141 and the piezoelectric element 120 are in more tight fit, thereby improving stiffness of the whole system; an outer ring surface of the wedge block 141 is vertically arranged, such that the piezoelectric element 120 is not easily destroyed due to extrusion when the piezoelectric element 120 is extruded by the wedge block 141 in the process in which the wedge block 141 presses downwards; the thickness of the wedge block 141 is linearly decreased along the direction from the first end 142 to the second end 143, therefore, in the process in which the wedge block 141 expands outwards in the descending process, the piezoelectric element 120 is subjected to an extrusion force which changes linearly, and the piezoelectric element 12 is not easily destroyed due to extrusion by the wedge block 141.

It can be understood that, the quantity of the wedge blocks 141 is not limited herein, for example, two, three or more wedge blocks can be available; the setting of the pre-tightening member 140 is not limited to the above embodiments, and other setting manners can be selected, as long as the pre-tightening members 140 are circularly distributed within the circular gap and the thickness of the first end 142 is larger than the thickness of the second end 143. Wherein the thickness of the wedge block 141 means the distance from the inner ring surface to the outer ring surface of the wedge block 141; fit setting between the inner ring surface of the wedge block 141 and the connecting part 112 means that the inner ring surface of the wedge block 141 is in fit with the part at which the inner ring surface is in contact with the connecting part 112; fit setting between the outer ring surface of the wedge block 141 and the piezoelectric element 120 means that the outer ring surface of the wedge block 141 is fit with the part at which the outer ring surface is in contact with the piezoelectric element 120, and the fit setting herein is not a complete fit in the strict sense, but is an approximate fit, that is, part of a gap is allowed to exist in the part at which the inner surface of the wedge block 141 is in contact with the connecting part 112 or exist in the part at which the outer ring surface of the wedge block 141 is in contact with the piezoelectric element 120.

Please refer to FIG. 4, in some optional embodiments, the piezoelectric element 120 includes two rounded valve bodies which are formed through cutting a circular ring along its axial direction, and the inner side surface and the outer side surface of the two rounded valve bodies are both vertically arranged, therefore, when the wedge block 141 presses downwards to expand outwards and extrude the piezoelectric element 120, the two rounded valve bodies will also expand outwards under the extrusion of the wedge block 141, while the mass block 130 which is sleeved outside the piezoelectric block 120 prevents the piezoelectric element 120 from expanding, such that the parts of the whole system are extruded mutually in the installation process of the installation pieces, and all the parts are in tight fit, thereby further improving system stiffness.

It can be understood that, the number of rounded valve bodies is not limited to two, and can also set to be more. In some other optional embodiments, the materials of the piezoelectric element 120 are not limited, for example, the piezoelectric element 120 can be made from ceramics or other materials.

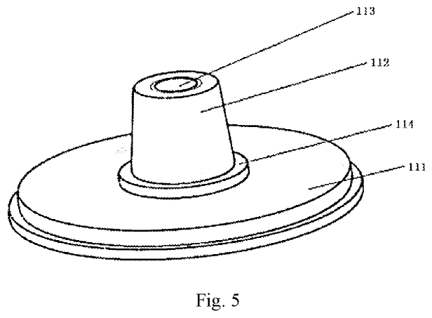

Please refer to FIG. 5, the supporting part 111 of the base 110 is of a round plate shape, the supporting part 111 is provided with a top surface and a bottom surface which are opposite to each other, the connecting part 112 is formed through extension along a direction from the middle part of the top surface of the round plate shape 111 towards the direction far away from the top surface, and in order to improve stiffness of the base 110, the supporting part 111 and the connecting part 112 are molded in one piece; the mounting hole 113 is arranged on an upper end face, far away from the supporting part 111, of the connecting part 112, and is formed through extension along a direction close to the supporting part 111; in order to be in better fit with the locking member 150, the inner side wall of the mounting hole 113 is vertically arranged, and the mounting hole 113 is internally provided with inner threads; in order to be better fit with the pre-tightening member 140, the thickness of the wall of the connecting part 112 changes gradually, and the thickness of one end, far away from the supporting part 111, of the wall of the connecting part 112 is smaller than the thickness of the end close to the supporting part 111, wherein the thickness of the wall of the connecting part 112 means the distance from the outer side wall of the connecting part 112 to the inner side wall of the mounting hole 113. It can be understood that, the setting manner of the base 110 is not limited herein, for example, the supporting part 111 can also be a rectangular plate, etc., as long as the connecting part 112 is of a cylinder shape and is arranged on the supporting part 111 and the mounting hole 113 extends axially along the connecting part 112.

In some other optional embodiments, the outer ring surface of the connecting part 112 is provided with a supporting flange 114 along its axial direction, the supporting flange 114 is higher than the plane in which the supporting part 111 is located, and the piezoelectric element 120 butts against the supporting flange 114. One part of the end face of the piezoelectric element 120 is arranged on the supporting flange 114, while the other part is arranged in a suspended manner, such that the piezoelectric element 120 can be subjected to a shearing force exerted by the mass block 130, thereby generating electric signals. Wherein the plane in which the supporting part 111 is located means the plane in which the top surface of the supporting part 111 is located, the supporting flange 114 is higher than the plane in which the top surface of the supporting part 111 is located, but is lower than the plane in which the upper end face, far away from the supporting part 111, of the connecting part 112 is located, such that the part, close to the end face of the supporting part 111, of the piezoelectric element 120 is arranged on the supporting flange 114, while the other part is arranged in a suspended manner.

In some optional embodiments, the mass block 130 has a circular structure which includes an inner ring surface and an outer ring surface which are opposite to each other, the inner ring surface of the mass block 130 is provided with a concave block 131, and the mass block 130 is arranged outside the piezoelectric element 120 in a hanging manner via the concave block 131. In these optional embodiments, the mass block 130 has a circular structure which can effectively prevent the piezoelectric element 120 sleeved in the mass block 130 and the wedge block 141 from expanding outwards. The mass block 130 is arranged outside the piezoelectric element 120 in a hanging manner via the concave block 131, such that the mass block 130 exerts a vertical pressure on the piezoelectric element 120, then the piezoelectric element 120 can response more sensitively. Further, the mass block 130 is a circular ring, the concave block 131 is ring-shaped, and the diameter of the ring-shaped concave 131 is greater than the diameter of the other part, except the concave block 131, of the inner ring surface of the mass block 130. The concave block 131 is arranged at the position, close to the supporting part 111, inside the mass block 130, and the concave block 131 is fit with the outer side wall of the piezoelectric element 120.

In some optional embodiments, the locking member 150 is an erection bolt, the stop part 152 is a nut on the erection bolt, and the mounting hole 113 is internally provided with threads which are fit with the erection bolt. It can be understood that, the locking member 150 can also be of other structures, so as to realize tight fit between the locking member and the mounting hole 113, and the structure is not limited herein.

An embodiment of the present invention further provides a annular shear piezoelectric acceleration sensor which includes a charge output element 100 of any of the above embodiments and which possesses the same advantages as the charge output element 100, and will not be repeated redundantly herein.

The present invention can be realized in other specific forms, without departing from the spirit and essential features thereof. For example, algorithms described in specific embodiments can be modified, while the system architecture does not depart from basic spirit of the present invention. Therefore, the current embodiments are deemed to be exemplary rather than restrictive embodiments in all respects, the scope of the present invention is defined by the appended claims rather than by the above description, moreover, all the modifications which fall within the scope of meanings and equivalents of the claims are all contained in the scope of the present invention.

1. A charge output element, comprising:
a base, comprising a supporting part and a cylindrical connecting part arranged on the supporting part, wherein the connecting part is provided with mounting holes axially extending along the connecting part;
a piezoelectric element, sleeved outside the connecting part, wherein a circular gap is formed between the piezoelectric element and the connecting part;
a mass block, sleeved outside the piezoelectric element and arranged above the supporting part in a suspended manner;
pre-tightening members, inserted into the circular gap, wherein the pre-tightening members are circularly distributed within the circular gap, the pre-tightening member comprises a first end and a second end which are opposite to each other, the second end is close to the supporting part, and the thickness of the first end is larger than the thickness of the second end; and
a locking member, comprising a columnar part and a stop part which are connected with each other, wherein the columnar part cooperates with the mounting hole to fasten the above elements, the stop part butts against the first end, such that the pre-tightening member provides a radial pretightening force to fasten the piezoelectric element, the mass block and the base.

2. The charge output element of claim 1, wherein the pre-tightening member comprises at least two wedge blocks, the at least two wedge blocks are distributed circularly along a circumferential direction of the connecting part within the circular gap, and the thickness of each wedge block is linearly decreased along a direction from the first end to the second end.

3. The charge output element of claim 2, wherein the at least two wedge blocks are formed by cutting a wedge ring along its axial direction.

4. The charge output element of claim 2, wherein each wedge block comprises an inner ring surface and an outer ring surface which are opposite to each other and which extend from the first end to the second end, the inner ring surfaces of the at least two wedge blocks are both fit with the connecting part, and the piezoelectric element is sleeved on the outer ring surfaces of the at least two wedge blocks.

5. The charge output element of claim 4, wherein the piezoelectric element is in direct contact with the outer ring surfaces of the at least two wedge blocks.

6. The charge output element of claim 5, wherein the outer ring surfaces of the at least two wedge blocks are vertically arranged.

7. The charge output element of claim 1, wherein the piezoelectric element comprises at least two rounded valve bodies which are formed by cutting a circular ring along its axial direction.

8. The charge output element of claim 1, wherein an outer ring surface of the connecting part is provided with a supporting flange along its axial direction, the supporting flange is higher than the plane in which the supporting part is located, and the piezoelectric element butts against the supporting flange.

9. The charge output element of claim 1, wherein the mass block has a circular structure which includes an inner ring surface and an outer ring surface opposite to each other, wherein the inner ring surface of the mass block is provided with a concave block, and the mass block is arranged outside the piezoelectric element in a hanging manner via the concave block.

10. A annular shear piezoelectric acceleration sensor, comprising the charge output element of claim 1,
wherein the charge output element comprises:
a base, comprising a supporting part and a cylindrical connecting part arranged on the supporting part, wherein the connecting part is provided with mounting holes axially extending along the connecting part;
a piezoelectric element, sleeved outside the connecting part, wherein a circular gap is formed between the piezoelectric element and the connecting part;
a mass block, sleeved outside the piezoelectric element and arranged above the supporting part in a suspended manner;
pre-tightening members, inserted into the circular gap, wherein the pre-tightening members are circularly distributed within the circular gap, the pre-tightening member comprises a first end and a second end which are opposite to each other, the second end is close to the supporting part, and the thickness of the first end is larger than the thickness of the second end; and
a locking member, comprising a columnar part and a stop part which are connected with each other, wherein the columnar part cooperates with the mounting hole to fasten the above elements, the stop part butts against the first end, such that the pre-tightening member provides a radial pretightening force to fasten the piezoelectric element, the mass block and the base.

11. The annular shear piezoelectric acceleration sensor of claim 10, wherein the pre-tightening member comprises at least two wedge blocks, the at least two wedge blocks are distributed circularly along a circumferential direction of the connecting part within the circular gap, and the thickness of each wedge block is linearly decreased along a direction from the first end to the second end.

12. The annular shear piezoelectric acceleration sensor of claim 11, wherein the at least two wedge blocks are formed by cutting a wedge ring along its axial direction.

13. The annular shear piezoelectric acceleration sensor of claim 11, wherein each wedge block comprises an inner ring surface and an outer ring surface which are opposite to each other and which extend from the first end to the second end, the inner ring surfaces of the at least two wedge blocks are both fit with the connecting part, and the piezoelectric element is sleeved on the outer ring surfaces of the at least two wedge blocks.

14. The annular shear piezoelectric acceleration sensor of claim 13, wherein the piezoelectric element is in direct contact with the outer ring surfaces of the at least two wedge blocks.

15. The annular shear piezoelectric acceleration sensor of claim 14, wherein the outer ring surfaces of the at least two wedge blocks are vertically arranged.

16. The annular shear piezoelectric acceleration sensor of claim 10, wherein the piezoelectric element comprises at least two rounded valve bodies which are formed by cutting a circular ring along its axial direction.

17. The annular shear piezoelectric acceleration sensor of claim 10, wherein an outer ring surface of the connecting part is provided with a supporting flange along its axial direction, the supporting flange is higher than the plane in which the supporting part is located, and the piezoelectric element butts against the supporting flange.

18. The annular shear piezoelectric acceleration sensor of claim 10, wherein the mass block has a circular structure which includes an inner ring surface and an outer ring surface opposite to each other, wherein the inner ring surface of the mass block is provided with a concave block, and the mass block is arranged outside the piezoelectric element in a hanging manner via the concave block.
